(19) United States
(12) Patent Application Publication
(10) Pub. No.: US 2004/0202378 A1
(43) Pub. Date: Oct. 14, 2004

(54) Method and apparatus for enhancing images based on stored preferences

(76) Inventors: Hawley Rising III, San Jose, CA (US); Richard Dominiak, San Francisco, CA (US); Clay Fisher, Belmont, CA (US); Eric Edwards, San Jose, CA (US)

Correspondence Address: Valley Oak Law, 5655 Silver Creek Valley Road, #106, San Jose, CA, 95138, US

(21) Appl. No.: 10/403,070

(22) Filed: Mar. 31, 2003

(51) Int. Cl. G06K 9/40

(52) U.S. Cl. 382/254

(57) ABSTRACT

The invention illustrates a system and method of providing, and storing enhancement parameters for an image. In one embodiment, the system and method comprises: selecting a first image; modifying the first image in response to an enhancement parameter; forming a second image based on the first image and the enhancement parameter; and selectively storing the enhancement parameter based on the first image and the second image. In another embodiment, the system and method comprises: selecting a first image; selecting a profile; modifying the first image in response to an enhancement parameter within the profile; forming a second image based on the first image and the enhancement parameter; and displaying the second image.

Other aspects and advantages of the invention will become apparent from the following detailed description, taken in conjunction with the accompanying drawings, illustrated by way of example of the principles of the invention.

### FIELD OF THE INVENTION

The present invention relates generally to enhancing images and, more particularly, to enhancing images while using stored preferences.

### BACKGROUND OF THE INVENTION

There have been many advances in digital photography. Digital cameras have become popular tools for both consumers and professional photographers alike. With advances in the user interfaces within digital cameras, the challenges of operating a digital camera to create digital images have become easier. Further, each successive generation of digital cameras brings forth an increase in quality. For example, each generation of digital cameras is designed with greater resolution, larger memory devices, and better optics.

Providing users with the capability of manipulating and customizing the resultant output of a digital image is one advantage of digital image. Users can typically alter the resultant output after the digital image has been created. Examples of manipulation and customization include removal of “red eye”, color correction, exposure correction, focus adjustment, crop enhancement, and the like.

However, users may find that manipulating and customizing each image is a time consuming task. Further, users may find it difficult to remember the numerous types of corrections that may be implemented on a digital image.

### SUMMARY OF THE INVENTION

The invention illustrates a system and method of providing and storing enhancement parameters for an image. In one embodiment, the system and method comprises: selecting a first image; modifying the first image in response to an enhancement parameter; forming a second image based on the first image and the enhancement parameter; and selectively storing the enhancement parameter based on the first image and the second image. In another embodiment, the system and method comprises: selecting a first image; selecting a profile; modifying the first image in response to an enhancement parameter within the profile; forming a second image based on the first image and the enhancement parameter; and displaying the second image. Other aspects and advantages of the invention will become apparent from the following detailed description, taken in conjunction with the accompanying drawings, illustrated by way of example of the principles of the invention.

### BRIEF DESCRIPTION OF THE DRAWINGS

The accompanying drawings, which are incorporated in and constitute a part of this specification, illustrate one embodiment of the invention and, together with the description, explain one embodiment of the invention. In the drawings,

FIG. 1 is a diagram illustrating an environment within which the invention may be implemented.

FIG. 2 is a simplified block diagram illustrating one embodiment in which the invention may be implemented.

FIG. 3 is a simplified block diagram illustrating a system, consistent with one embodiment of the invention.

FIG. 4 is a flow diagram consistent with one embodiment of the invention.

FIG. 5 is a flow diagram consistent with one embodiment of the invention.

FIG. 6 is a flow diagram consistent with one embodiment of the invention.

### DETAILED DESCRIPTION

The following detailed description of the invention refers to the accompanying drawings. The detailed description does not limit the invention. Instead, the scope of the invention is defined by the appended claims and equivalents.

The invention includes methods and apparatus for developing seamless and universal interfaces for consumer electronic devices. The invention also includes methods and apparatus for enabling a variety of different interfaces from various consumer electronic devices to communicate with each other. The invention also includes methods and apparatus for enabling a variety of different interfaces from various consumer electronic devices to communicate with an application.

Those skilled in the art will recognize that many other implementations are possible, consistent with the present invention.

A. Environment and Architecture

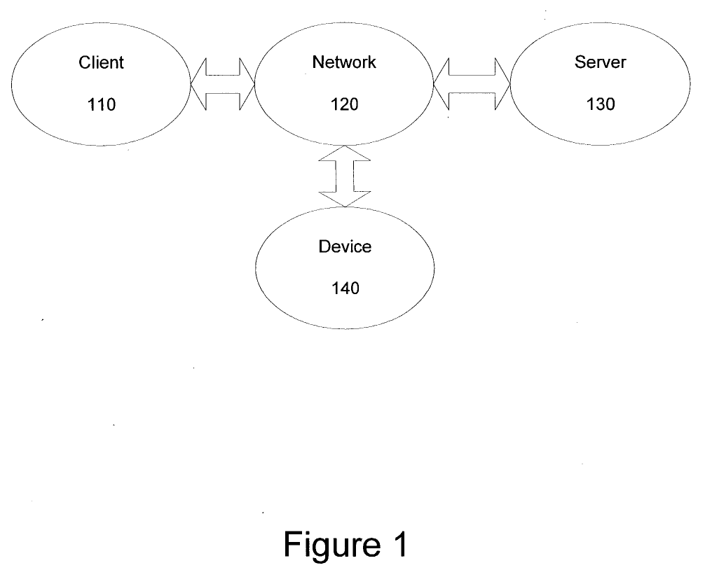

FIG. 1 is a diagram illustrating an environment within which the invention may be implemented. The environment includes a client 110, a network 120, a server 130, and a device 140.

The client 110 may be a consumer electronics device. The consumer electronics device may include a computer, a digital camera, a telephone, a pager, and the like. The client 110 may be configured to be utilized by a user.

The device 140 may be a consumer electronics device. In one embodiment, the device 140 may be configured to be operated by a user. In another embodiment, the device 140 may be configured to be operated by a user remotely through the client 110.

The network 120 interfaces with the client 110, the device 140, and the server 130. In one embodiment, the network 120 is the Internet. In another embodiment, the network 120 may be any transmission medium between the client 110 and the server 130.

The sever 130 is a device configured to interface with the client 110 and the device 140 through the network 120.

The client 110, the device 140, and/or the server 130 may include a combination of software, hardware, and/or firmware to provide functionality for the invention.

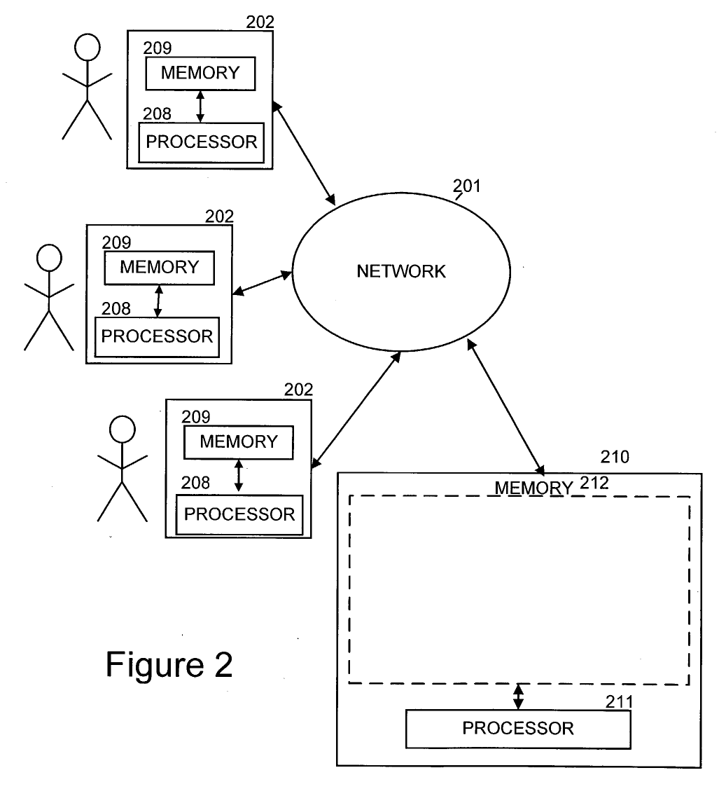

FIG. 2 is a simplified diagram illustrating an exemplary architecture in which the present invention may be implemented. The exemplary architecture includes a plurality of client devices 202, a server device 210, and a network 201. In one embodiment, the network 201 may be the Internet. The plurality of client devices 202 are each configured to include a computer-readable medium 209, such as random access memory, coupled to a processor 208. Processor 208 executes program instructions stored in the computer-readable medium 209. In another embodiment, the plurality of client devices 202 may also include a number of additional external or internal devices, such as, without limitation, a mouse, a CD-ROM, a keyboard, and a display.

The interface framework may be stored on the plurality of client devices 202 within each computer-readable medium 209.

Similar to the plurality of client devices 202, the server device 210 may include a processor 211 coupled to a computer-readable medium 212. The server device 210 may also include a number of additional external or internal devices, such as, without limitation, a secondary storage element, such as database 240.

The interface framework may be stored on the server device 210 within each computer-readable medium 212.

The plurality of client processors 208 and the server processor 211 can be any of a number of well known computer processors, such as processors from Intel Corporation, of Santa Clara, Calif. In general, the plurality of client devices 202 may be any type of computing platform connected to a network and that interacts with application programs, such as a digital assistant or a “smart” cellular telephone or pager. The server 210, although depicted as a single computer system, may be implemented as a network of computer processors.

The plurality of client devices 202 and the server 210 may include the interface framework. In one embodiment, the plurality of computer-readable medium 209 and 212 may contain, in part, the interface framework. Additionally, the plurality of client devices 202 and the server 210 are configured to receive and transmit electronic messages for use with the interface framework. Similarly, the network 201 is configured to transmit electronic messages for use with the invention.

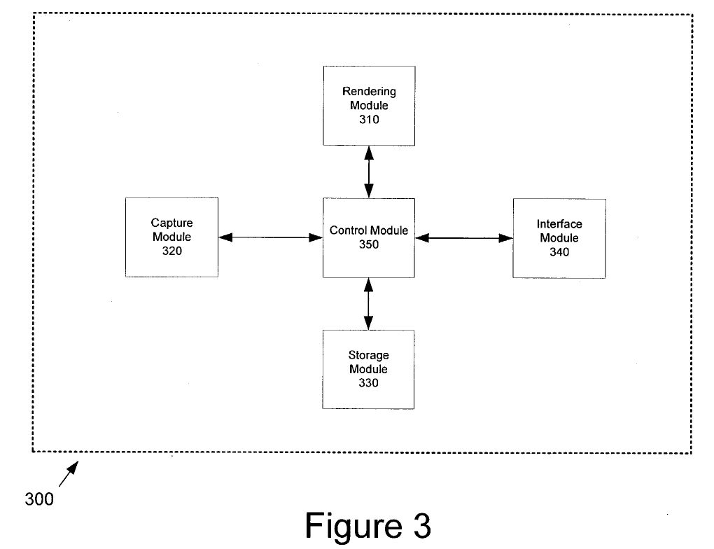

FIG. 3 illustrates one embodiment of an enhancement system 300. The enhancement system 300 includes a rendering module 310, a capture module 320, a storage module 330, an interface module 340, and a control module 350. In one embodiment, the control module 350 is configured to communicate with the rendering module 310, the capture module 320, the storage module 330, and the interface module 340.

In one embodiment, the control module 350 is configured to coordinate tasks, requests and communications between the rendering module 310, the capture module 320, the storage module 330, and the interface module 340.

In one embodiment, the rendering module 310 is configured to render an image based on the image data and specific enhancement parameters specified by the control module 350.

In one embodiment, the image data may be stored within the storage module 330. In one embodiment, the image data may be created outside the system 300. In another embodiment, the system 300 also includes at least one sensor to capture the image data.

In one embodiment, the specific enhancement parameters may include color balance, lighting effects, sharpness, and other parameters. In one embodiment, these specific enhancement parameters may be stored within the storage module 330. In one embodiment, the rendering module 310 utilizes the image data in conjunction with the specific enhancement parameters to form the resultant image.

In one embodiment, the capture module 320 is configured to identify a specific image and to process corresponding image data. In one embodiment, the capture module 320 is configured to identify the specific image from many images. In one embodiment, the control module 350 instructs the capture module 320 to identify the specific image. In one embodiment, the specific image and corresponding image data are stored within the storage module 330.

In one embodiment, the capture module 320 also is configured to identify values of the specific enhancement parameters associated with the image. For example, the color balancing enhancement parameter includes unique values specific to the selected image. In one embodiment, the enhancement parameters and the corresponding values are stored in the storage module 330 for a particular image.

In one embodiment, the storage module 330 is configured for storing data. This data may include image data, enhancement parameters corresponding with particular images, values for the enhancement parameters corresponding with particular images, and enhancement profiles. In one embodiment, the image data may be stored in a TIFF format, a JPEG format, and the like.

In one embodiment, the enhancement profiles are associated with a specific user. In one embodiment, each enhancement profile belonging to a specific user may be customized and stored within the storage module 330. In one embodiment, the enhancement profile includes a combination of enhancement parameters and corresponding values.

In one embodiment, the interface module 340 is configured to receive user instructions to operate the system 300. In one embodiment, the interface module 340 is configured to receive an image selection from a user, feedback regarding the image from the user, various enhancement parameter selections, and enhancement profile selections.

In one embodiment, the interface module 340 is configured to provide a displayed image to the user. In one embodiment, the displayed image includes an original unmodified image based on the original image data. In another embodiment, the displayed image includes a modified image based on an enhancement parameter and corresponding value. In yet another embodiment, the displayed image includes a modified image based on a profile selected by the user.

The system 300 in FIG. 3 is shown for exemplary purposes and is merely embodiment of the invention. Additional modules may be added to the system 300 without departing from the scope of the invention. Similarly, modules may be combined or deleted without departing from the scope of the invention.

B. Operation

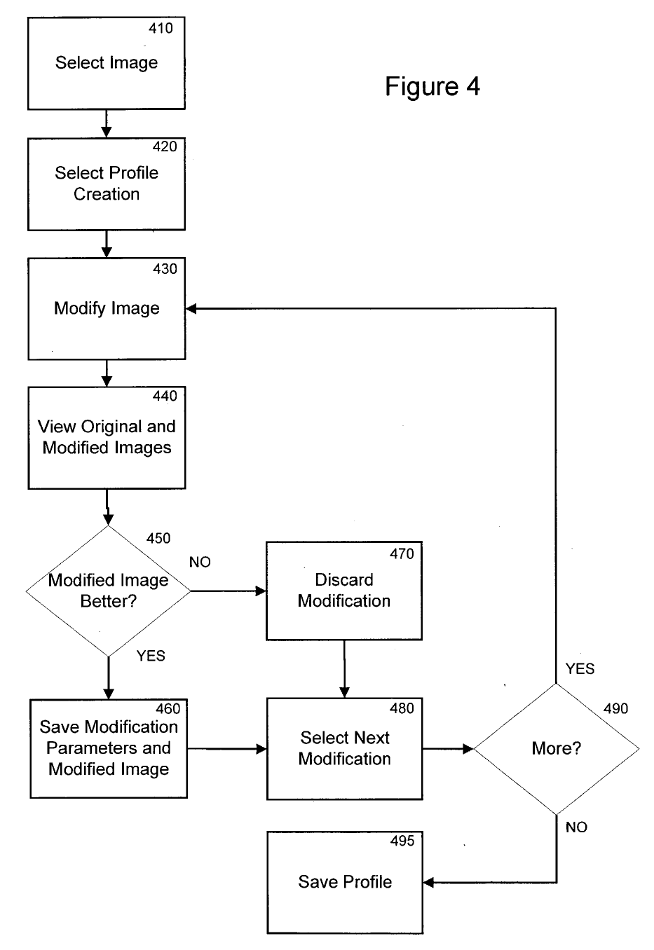

The flow diagrams as depicted in FIGS. 4, 5, and 6 are merely one embodiment of the invention. The blocks within the flow diagrams may be performed in a different sequence without departing from the spirit of the invention. Further, blocks may be deleted, added, or combined without departing from the spirit of the invention.

The flow diagram in FIG. 4 illustrates modifying image data and creating a profile according to one embodiment of the invention.

In Block 410, an image is selected. In one embodiment, the image and the associated image data are identified within the capture module 320 (FIG. 3).

In Block 420, a selection is made to create a profile. In one embodiment, the profile includes modifications to a selected image based on specified enhancement parameters and associated values. In one embodiment, the profile corresponds to a specific user. In one embodiment, the profile may be stored within the storage module 330 (FIG. 3).

In Block 430, the image is modified according to one of the enhancement parameters. In one embodiment, the enhancement parameters includes color balancing, exposure balancing, sharpness, and special effects such as red eye removal, mosaic effect, and the like. In one embodiment, the image may be modified within the rendering module 310, the capture module 320, and/or the control module 350. In one embodiment, the selection of the particular enhancement parameter and the associated value may be directed by the control module 350.

In Block 440, the original image and the modified image are displayed. In one embodiment, the original and modified images are displayed via the rendering module 310.

In Block 450, a comparison between the modified image and the original image is made. In one embodiment, the user selects whether the original image or the modified image is more suitable. In another embodiment, the system 300 selects whether the original image of the modified image is more suitable.

If the modified image is more suitable, then the particular enhancement parameter and associated value is stored in Block 460. In one embodiment, the particular enhancement parameter is the parameter which was utilized to modify the image in the Block 430. In one embodiment, the particular enhancement parameter and associated value is stored within the storage module 330. In one embodiment, the storage of the particular enhancement and the associated value corresponds to a specific profile associated as selected in the Block 420.

If the modified image is not suitable, then the particular enhancement parameter and associated value which modified the original image is discarded in Block 470.

After the Blocks 460 and 470, a subsequent enhancement parameter is selected in Block 480. Recall that a plurality of enhancement parameters may modify the original image. The particular enhancement parameter utilized in the Block 430 is merely one of the plurality of enhancement parameters.

In Block 490, if there is a subsequent enhancement parameter, then this subsequent enhancement parameter is directed back to the Block 430 to modify the original image with the subsequent enhancement parameter.

In the Block 490, if there are no additional subsequent enhancement parameters, then the profile is saved in Block 495. In one embodiment, the profile may include one or more enhancement parameters with the associated value(s). Additionally, in another embodiment, the profile may also include the original image. In yet another embodiment, the profile may also include the modified image based on the enhancement parameter(s) stored within the profile.

In one embodiment, the profile is stored within the storage module 330. In one embodiment, the profile corresponds with a particular user.

In an alternate embodiment, returning to the Block 430, the original image may be simultaneously modified by multiple enhancement parameters. For example, multiple enhancement parameters may be selected to modify the original image and form the modified image in the Block 440.

In another embodiment, the original image may be simultaneously modified by multiple enhancement parameters based on the enhancement parameters stored in the Block 460. For example, the particular enhancement parameters that are stored by the Block 460 may be utilized to modify the original image in the Block 430 along with the subsequent enhancement parameter as selected in the Block 490.

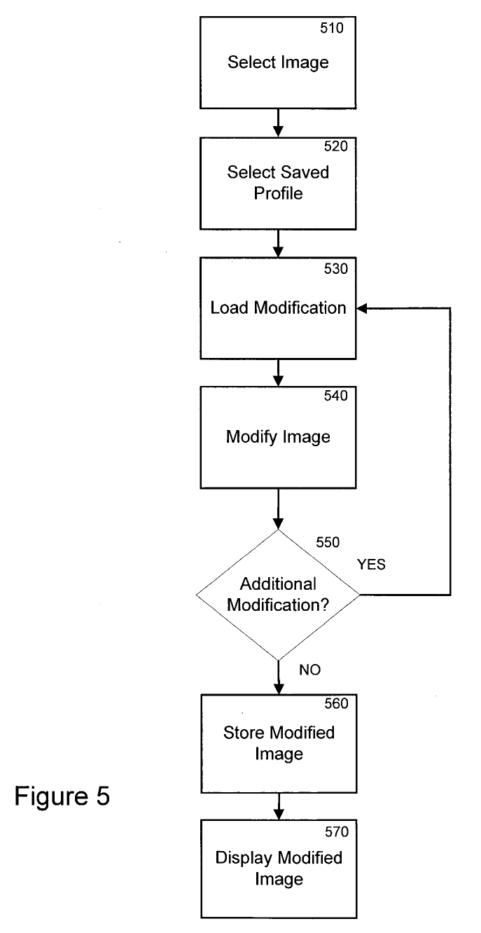

The flow diagram in FIG. 5 illustrates viewing an image via enhancements saved within a profile according to one embodiment of the invention.

In Block 510, an image is selected. In one embodiment, the image and the associated image data are identified within the capture module 320 (FIG. 3).

In Block 520, a profile is selected. In one embodiment, the profile may be selected as a customized name such as “Joe's Portraits”, “Landscape Pics with Sepia Filter”, “People Pics with Mosaic”, and the like. In one embodiment, the profile includes one or more enhancement parameters with the corresponding values.

In another embodiment, the enhancement system recognizes the image that was selected in the Block 510 and matches this selected image with a profile of another image which is found by the enhancement system. This other image and corresponding profile may be stored within the enhancement system or at a remote location. The user of the enhancement system is offered a choice utilizing the profile of another image which has similar characteristics of the image selected by the user in the Block 510 to enhance the user's selected image.

In yet another embodiment, the user may view other images through the enhancement system and copy the enhancement parameters associated with any of the images for use with the selected image.

In Block 530, one of the enhancement parameters identified in the profile is loaded.

In Block 540, the original image is modified via the enhancement parameter loaded in the Block 530. In one embodiment, if there are additional enhancement parameters, the modified image becomes the base image on which additional modifications can be made.

In Block 550, if an additional enhancement parameter is found corresponding with the profile, then the additional enhancement parameter is loaded in the Block 530.

In Block 550, if no additional enhancement parameters are found, then the modified image is stored in Block 560. In one embodiment, the modified image is stored within the storage module 330. In another embodiment, the modified image is stored in a remote device.

In Block 570, the modified image is displayed. In one embodiment, the rendering module 310 processes the modified image for display. In another embodiment, the modified image is transmitted to a remote device for display.

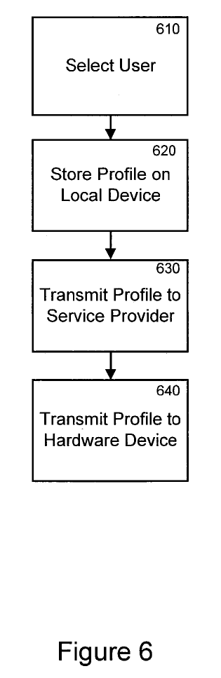

The flow diagram in FIG. 6 illustrates managing a profile according to one embodiment of the invention.

In Block 610 a user is identified. In one embodiment, the user may be identified through the use of a password. In another embodiment, the user may be identified through the use of a biometric parameter such as a finger print or an eye scan.

In Block 620, a profile that is identified with a specific user is stored on a local device. In one embodiment, the local device is the same device that formatted the profile. In one embodiment, the local device temporarily stores the profile and associated information.

In Block 630, a user may selectively transmit the profile and associated information to a service provider for storage. In one embodiment, the service provider may be represented as the server 130 (FIG. 1).

In Block 640, a user may selectively transmit the profile and associated information to a remote device. In one embodiment, the remote device may be represented as the device 140 (FIG. 1). In one embodiment, the remote device may include one of a digital camera, personal computer, pager, cellular phone, a personal digital assistant, and the like.

C. Conclusion

The foregoing descriptions of specific embodiments of the invention have been presented for purposes of illustration and description. For example, the invention is described within the context of creating profiles for modifying digital images as merely one embodiment of the invention. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed:

1. A method comprising:
selecting a first image;
modifying the first image in response to an enhancement parameter;
forming a second image based on the first image and the enhancement parameter; and
selectively storing the enhancement parameter based on the first image and the second image.

2. The method according to claim 1 further comprising viewing the first image and the second image.

3. The method according to claim 1 wherein the enhancement parameter includes one of a color balancing parameter, an exposure balancing parameter, and a special effects parameter.

4. The method according to claim 1 further comprising storing a value corresponding to the enhancement parameter.

5. The method according to claim 1 further comprising storing a profile including the enhancement parameter.

6. The method according to claim 1 further comprising selecting one of the first image and the second image.

7. The method according to claim 1 wherein storing the enhancement parameter occurs within a profile.

8. The method according to claim 1 wherein the first image is one of a TIFF file and an MPEG file.

9. A method comprising:
selecting a first image;
selecting a profile;
modifying the first image in response to an enhancement parameter within the profile;
forming a second image based on the first image and the enhancement parameter; and
displaying the second image.

10. The method according to claim 9 wherein the enhancement parameter includes one of a color balancing parameter, an exposure balancing parameter, and a special effects parameter.

11. The method according to claim 9 wherein the profile includes a value corresponding to the enhancement parameter.

12. The method according to claim 9 further comprising storing the second image.

13. A system, comprising:
a storage module configured for storing a profile containing an enhancement parameter; and
a rendering module configured for receiving the enhancement parameter, modifying an original image based on the enhancement parameter, and displaying the modified image.

14. The system according to claim 13 further comprising a capture module configured to identify the original image.

15. The device according to claim 13 wherein the profile corresponds to a user.

16. The device according to claim 13 wherein the profile includes a plurality of enhancement parameters.

17. The device according to claim 16 wherein each of the plurality of enhancement parameters has a corresponding value.

18. The device according to claim 13 wherein the enhancement parameter includes one of a color balancing parameter, an exposure balancing parameter, and a special effects parameter.

19. A computer-readable medium having computer executable instructions for performing a method comprising:
selecting a first image;
modifying the first image in response to an enhancement parameter;
forming a second image based on the first image and the enhancement parameter; and
selectively storing the enhancement parameter based on the first image and the second image.

20. A system, comprising:
means for storing configured for storing a profile containing an enhancement parameter; and
means for rendering configured for receiving the enhancement parameter, modifying an original image based on the enhancement parameter, and displaying the modified image.
